(19) United States
(12) Patent Application Publication
(10) Pub. No.: US 2008/0190898 A1
(43) Pub. Date: Aug. 14, 2008

(54) Storage Packet For Welding Flux Comprising a Sandwich Structure of the Polymer/Metal Film Type Method For a Storage of a Welding Flux in Such a Packet and Method For Arc Welding Using a Welding Flux Stored in Such a Packet

(75) Inventor: Stephan Starck, Grunstadt (DE)

Correspondence Address: YOUNG & THOMPSON, 209 Madison Street, Suite 500, ALEXANDRIA, VA, 22314, US

(73) Assignees: Oerlikon GMBH, Eisenberg (DE); Air Liquide Welding France, Paris (FR)

(21) Appl. No.: 11/911,397

(22) PCT Filed: Apr. 6, 2006
(86) PCT No.: PCT/FR2006/050308

§ 371 Date: Feb. 12, 2008

(30) Foreign Application Priority Data
Apr. 12, 2005 (EP) 05102871.0

(51) Int. Cl. B23K 9/18; B65D 33/00

(52) U.S. Cl. 219/73.1; 383/105; 219/73

(57) ABSTRACT

The invention relates to a storage packet for welding flux, in the form of a bag (1) containing welding flux (5) and with at least one layer of thermo-welded polymer (3a, 3b) and at least one metal film (2), superimposed one on the other and a structure with flexible deformable walls forming said bag (1), characterized in that said bag (1) is hermetically sealed and pressured within the bag is less than atmospheric pressure. The invention further relates to a method for storage of welding flux in such packet.

The invention relates in particular to a package for packaging a welding flux, to a method of packaging it and to its use, in particular in submerged art welding or electroslag welding.

When certain arc welding processes are carried out, it is essential to use a granular or pulverant flux for covering the welding zone, that is to say the joint and the arc, during the actual welding, such as for example submerged arc welding or electroslag welding.

Now, these welding fluxes are sensitive to moisture and must therefore be stored away from any source of moisture, especially ambient moisture.

Presently, welding fluxes are packaged using three methods, namely in packages, such as bags or containers, made of polymers, in particular polyethylene, in paper bags, with a polyethylene coating, or metal boxes or containers.

However, such packaging has certain drawbacks.

Thus, containers made of polymers and polyethylene-coated paper bags do not completely block water vapor, which can infiltrate, during the storage time, into the package and degrade the flux contained therein, therefore requiring the user to dry the flux before use. This is neither very practical, nor always reliable under industrial conditions, and is also expensive.

Moreover, metal packages are generally very expensive and more complex to manufacture. They are also difficult to handle, to place on pallets and to transport.

The problem that therefore arises is how to provide a simple package for packaging a welding flux which makes it possible to keep the flux that it contains away from moisture, even after a long storage time, which is easy to manufacture and is inexpensive, which allows the flux thus packaged to be easily transported and handled, and which immediately indicates to the user whether the package has been pierced during its transport or its storage.

One solution to this problem is a package for packaging a welding flux, having the form of a bag containing a welding flux and comprising at least one heat-sealable polymer layer and at least one metal foil, these being superposed on one another in a structure having a flexible and deformable wall forming said bag, characterized in that the bag is hermetically sealed and the pressure inside said bag is below atmospheric pressure, i.e. that is to say the inside of the bag is under at least a partial vacuum, and therefore under reduced pressure.

After the bag has been filled with the welding flux, all or some of the air or gas in the package is therefore sucked out by gas suction elements or means, such as a pipette, a cannula or the like, connected to a vacuum pump or the like, so as to create a reduced pressure inside the bag.

Next, the opening of the bag via which this suction takes place is hermetically sealed, for example by bonding or thermal bonding, before the ambient air can penetrate there into. The pressure prevailing inside the bag is therefore maintained below the ambient atmospheric pressure (1 atmosphere), which means that the internal surface or surfaces of the wall of the bag will conform to the contours of the flux that it contains when no leak through or hole in said wall exists, that is to say while the bag is hermetically sealed.

In this way, the user has an indicator that indicates to him whether or not the package has been pierced throughout the time between its closure, while it is being packaged, and the moment when it is opened in order to use the flux contained therein, since if a leak occurs or a hole is produced, the ambient air will immediately enter therein and a user will be able to see this instantly by simple visual examination.

Depending on the case, the package of the invention may include one or more of the following features:
the structure forming said bag comprises at least one polymer layer covering each of the surfaces of a metal foil, that is to say the structure is formed from at least two polymer layers lying on each side of the metal foil, and preferably the structure forming the bag is a sandwich structure of the polymer/metal foil/polymer type;
the wall of the bag deforms and conforms to the contours of the flux so as to keep said flux in place when the pressure in the bag is below the external atmospheric pressure;
the bag is hermetically sealed along a closure line or area, after the flux has been introduced into said bag and at least a partial vacuum created therein. The closure line or area is located at or near the upper opening of the bag via which the flux is extracted from the bag during its use;
the metal foil is an aluminum foil having a thickness of less than 100 μm, preferably between 5 and 25 μm;
at least one polymer layer lying to the inside of the bag is a layer of heat-sealable polymer, preferably polyethylene;
at least one polymer layer lying to the outside of the bag is a polyethylene layer or a polyamide layer;
it has a capacity of less than 3 m³, preferably between 0.005 and 2 m³; and
the structure forming said bag comprises, in succession from the inside of the bag to the outside, an internal polyethylene layer, an aluminum foil, a polyamide layer and an external polyethylene layer.

A package according to the invention is particularly suitable for packaging a welding flux in the form of a powder, granules or mixtures thereof.

The invention also relates to an arc welding process employing a welding flux packaged in a package in the form of a bag according to the invention, in particular a submerged arc welding process or an electroslag welding process.

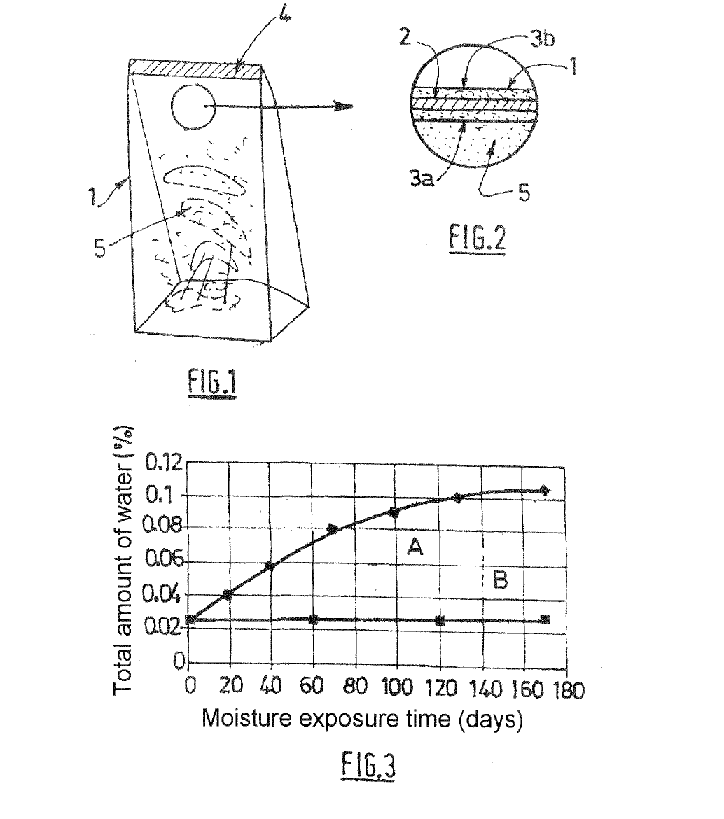

The package for packaging a flux of the invention is shown schematically in appended FIGS. 1 and 2.

As shown in FIG. 1, the package has the form of a bag 1 containing the welding flux 5, so as to keep it away from moisture during its transport or its storage.

FIG. 2 is an enlarged view in cross section of the circled area of the bag 1 in FIG. 1, enabling the sandwich structure of the bag 1 to be clearly seen.

More precisely, the wall of the bag 1 is formed from an aluminum layer 2, preferably having a thickness of 5 to 25 μm, sandwiched between an internal heat-sealable polymer layer 3a, in contact with the flux 5, and an external polymer layer 3b. The polymers of the two layers 3a, 3b may be the same or different.

Preferably, the internal layer 3a is made of a polymer that may be welded through the action of heat (a heat-sealable polymer), such as polyethylene, while the external layer 3b may be made of a polymer that is not weldable but does have a good puncture resistance.

The layers 2 and 3a, 3b forming the sandwich structure may be obtained by fastening together superposed sheets of aluminum and heat-sealable polymer, such as polyethylene, which is particularly well suited for the invention.

On closing the bag 1, the surfaces of its facing internal wall or walls come into contact with each other, and the opposed internal polyethylene layers 3a may be welded together by applying heat and pressure along a closure line 4, as may be seen in FIG. 1.

Prior to this hermetic sealing, the inside of the bag is placed under vacuum by sucking out the gaseous atmosphere contained therein. The aluminum layer 2 acts as a barrier to any ingress of moisture into the bag 1 over the course of time and guarantees that the flux 5 therein is kept dry, despite long storage times.

The polyethylene layers 3a, 3b serve in particular to increase the mechanical strength of the bag 1.

FIG. 3 shows the behavior, over the course of time (in days), of the flux contained in a packaging bag according to the prior art (bag A) and of the flux contained in a bag according to the present invention (bag B) when these bags are placed in a humid atmosphere so as to test their capability of preserving the flux that they contain from moisture.

Bag A is a bag according to the prior art, formed from a sheet constituting a polyethylene layer 150 μm in thickness.

Bag B is a bag according to the invention, comprising a polyethylene layer (like bag A), an additional 12 μm aluminum layer and another polyethylene layer. In other words, bag B is formed from a sandwich structure consisting of an aluminum foil sandwiched between two layers of a polyethylene covering.

The two bags were stored under the same temperature and humidity conditions, namely 27° C. and 80% relative humidity.

As may be seen, at the start (t=0), the flux contained in bags A and B contains 0.02% moisture by weight, that is to say a standard water content in fluxes, since a flux is never completely devoid of residual baking moisture.

Now, as may be seen in FIG. 3, after 180 days of storage, bag B according to the invention has prevented any ingress of moisture into the bag liable to come into contact with the flux that it contains.

In contrast, bag A according to the prior art is almost immediately contaminated with moisture.

In practice, it is estimated that a flux must contain at most 0.05% moisture and that above this amount it must be dried in an oven before use. This is because welding with too wet a flux may lead to defects in the welded joint, such as microcracks, porosity or cold cracks, which are deleterious to the metallurgical properties of the joint.

More precisely, the moisture present in the welding flux results in a transfer of hydrogen into the weld, which may induce cracks and/or porosity. The maximum moisture content that can be tolerated in a flux depends on the type of steel that has to be welded: the higher the mechanical characteristic of the steel, the less the weld can accept hydrogen without cracking. In addition, it also depends on the coefficient of hydrogen transfer into the molten metal from the moisture in the flux. Therefore, for each flux, there exists a moisture/hydrogen relationship and it is possible to fix a maximum hydrogen content according to the steel that is welded. Depending on the flux and the steel, it is often required that the moisture content of the flux at the moment of use in welding be less than 0.04%, or even 0.03%.

By applying these criteria, it has been found that the flux of bag B according to the invention may be used, without any need to redry it, after 180 days of storage, whereas the flux contained in bag A according to the prior art must be redried whenever it has been stored for more than about 32 days.

FIG. 3 therefore clearly shows the technical effect provided by a bag according to the invention, the envelope or wall of which is made up of several layers 3a, 3b of polyethylene or another heat-weldable polymer, and an aluminum layer 2, as explained above.

The bag 1 of the invention may comprise more than two or three polymer layers or metal foils.

Thus, in a particularly preferred embodiment, the structure forming the bag 1 of the invention comprises, in succession from the inside of the bag to the outside, an internal polyethylene layer 3a coming into contact with the flux 5, an aluminum foil 2, a polyamide layer and an external polyethylene layer 3b in contact with the ambient air.

Furthermore, it is also possible to envision a bag 1 having a “composite” structure in which at least a polymer layer, a metal foil, a polymer layer, a metal foil and another polymer layer alternate.

In all cases, the polymer layers may be fastened to or deposited on the aluminum foil by conventional techniques, for example by colamination, coextrusion or any other suitable technique.

Before the bag is hermetically sealed, the air contained therein is sucked out by a pipette, a cannula or the like, connected to a vacuum pump or the like, so as to create an at least partial vacuum therein, that is to say to obtain inside the bag, and therefore in contact with the flux, a pressure below the atmospheric pressure, when the bag is hermetically sealed.

Given that the wall of the bag is flexible and deformable, the pressure of the ambient air compresses it and deforms it in such a way that the internal surface of said wall conforms to the contours of the flux contained therein and keeps it in position.

In other words, the flux in the bag is kept in position by the wall or walls of the bag and can no longer move or shift within the package as long as the reduced pressure is maintained in the bag. The bag must therefore close up and form a compact solid mass. At the point where there is no flux, for example at the top end of the bag, the internal surfaces of the walls of the bag “stick” together owing to the reduced pressure therein.

When the bag is pierced, either unintentionally during its storage or transport, or intentionally during its use, the ambient air penetrates the bag owing to the reduced pressure therein and progressive pressure reequilibration inside the bag is observed until atmospheric pressure, i.e. 1 atmosphere, is reached. The flux relaxes, as it is no longer held in place by the walls of the bag.

The two different states of the bag are very easy for a user to distinguish, in particular by simple visual examination, thereby allowing him to immediately determine whether the flux contained therein is usable as such or whether it has to be scrapped or dried.

To be able to solve the abovementioned problem, it is therefore essential for the bag of flux of the invention to be not only formed from several layers or sheets superposed one on top of another in a flexible and deformable structure, but also for a reduced pressure to be created therein and maintained during the storage and transport of the bag, until it is opened by the user for the purpose of using it, for example in welding.

1. A package for packaging a welding flux, having the form of a bag (1) containing a welding flux (5) and comprising at least one heat-sealable polymer layer (3a, 3b) and at least one metal foil (2), these being superposed on one another in a structure having a flexible and deformable wall forming said bag (1), characterized in that said bag (1) is hermetically sealed and the pressure inside said bag is below atmospheric pressure.

2. The package as claimed in claim 1, characterized in that the structure forming said bag (1) comprises at least one polymer layer (3a, 3b), each layer covering the surfaces of a metal foil (2), and preferably the structure forming the bag (1) is a sandwich structure of the polymer/metal foil/polymer type.

3. The package as claimed in claim 1, characterized in that the metal foil (2) is an aluminum foil having a thickness of less than 100 μm, preferably between 5 and 25 μm.

4. The package as claimed in claim 1, characterized in that at least one polymer layer (3a) lying toward the inside of the bag (1) is a layer of heat-sealable polymer, preferably polyethylene, and/or at least one polymer layer (3b) lying toward the outside of the bag (1) is a polyethylene layer or polyamide layer.

5. The package as claimed in claim 1, characterized in that the wall of the bag (1) deforms and conforms to the contours of the flux (5) so as to keep said flux (5) in place.

6. The package as claimed in claim 1, characterized in that it has a capacity of less than 3 m³, preferably between 0.005 and 2 m³.

7. The package as claimed in claim 1, characterized in that the bag (1) is sealed along a closure line or area (4), after the flux (5) has been introduced into said bag (1) and at least a partial vacuum created therein.

8. The package as claimed in claim 1, characterized in that the structure forming said bag (1) comprises, in succession from the inside of the bag (1) to the outside, an internal polyethylene layer (3a), an aluminum foil (2), a polyamide layer and an external polyethylene layer (3b).

9. An arc welding process employing a welding flux (5) packaged in a package in the form of a bag (1) as claimed in claim 1, in particular a submerged arc welding process or an electroslag welding process.

10. A method of packaging a welding flux in a package as claimed in claim 1, whereby the following steps are carried out:
a) a welding flux is introduced into a package in the form of a bag (1) formed from at least one heat-sealable polymer layer (3a, 3b) and at least one metal foil (2), which are superposed on one another as a structure having at least one flexible wall;
b) some of the gaseous atmosphere within the package, particularly air, is at least partly extracted so as to reduce the internal pressure of the bag until a pressure below atmospheric pressure is obtained inside said bag; and
c) after step b) of creating at least a partial vacuum, said bag is hermetically sealed.

11. The package as claimed in claim 2, characterized in that at least one polymer layer (3a) lying toward the inside of the bag (1) is a layer of heat-sealable polymer, preferably polyethylene, and/or at least one polymer layer (3b) lying toward the outside of the bag (1) is a polyethylene layer or polyamide layer.

12. The package as claimed in claim 3, characterized in that at least one polymer layer (3a) lying toward the inside of the bag (1) is a layer of heat-sealable polymer, preferably polyethylene, and/or at least one polymer layer (3b) lying toward the outside of the bag (1) is a polyethylene layer or polyamide layer.

13. The package as claimed in claim 2, characterized in that the wall of the bag (1) deforms and conforms to the contours of the flux (5) so as to keep said flux (5) in place.

14. The package as claimed in claim 3, characterized in that the wall of the bag (1) deforms and conforms to the contours of the flux (5) so as to keep said flux (5) in place.

15. The package as claimed in claim 2, characterized in that it has a capacity of less than 3 m³, preferably between 0.005 and 2 m³.

16. The package as claimed in claim 3, characterized in that it has a capacity of less than 3 m³, preferably between 0.005 and 2 m³.

17. The package as claimed in claim 2, characterized in that the bag (1) is sealed along a closure line or area (4), after the flux (5) has been introduced into said bag (1) and at least a partial vacuum created therein.

18. The package as claimed in claim 3, characterized in that the bag (1) is sealed along a closure line or area (4), after the flux (5) has been introduced into said bag (1) and at least a partial vacuum created therein.

19. The package as claimed in claim 2, characterized in that the structure forming said bag (1) comprises, in succession from the inside of the bag (1) to the outside, an internal polyethylene layer (3a), an aluminum foil (2), a polyamide layer and an external polyethylene layer (3b).

20. The package as claimed in claim 3, characterized in that the structure forming said bag (1) comprises, in succession from the inside of the bag (1) to the outside, an internal polyethylene layer (3a), an aluminum foil (2), a polyamide layer and an external polyethylene layer (3b).
